(19) United States
(12) Patent Application Publication
(10) Pub. No.: US 2003/0020045 A1
(43) Pub. Date: Jan. 30, 2003

(54) Scintillator

(76) Inventors: Seiji Kobayashi, Ushiku-shi (JP); Kazutomi Yamamoto, Ushiku-shi (JP)

Correspondence Address: Andrew R. Basile, YOUNG & BASILE, P.C., Suite 624, 3001 West Big Beaver Road, Troy, MI, 48084-3107, US

(21) Appl. No.: 10/202,602

(22) Filed: Jul. 24, 2002

(30) Foreign Application Priority Data
Jul. 25, 2001 (JP) 2001-225,142

(51) Int. Cl. C09K 11/68

(52) U.S. Cl. 252/301.5

(57) ABSTRACT

A scintillator for detecting radiation such as x-rays or y-rays, improved with the quantity of light without deteriorating the attenuation time of fluorescence, in which single crystals of tungstate are used and arranged in a crystal orientation that the crystal face where atoms maintain dense configuration and the incident direction of the radiation are in parallel with each other, the cleavage face being selected as the crystal face where atoms maintain dense configuration.

### BACKGROUND OF THE INVENTION

1. Field of the Invention

This invention concerns a scintillator for detecting radiation such as X-rays or γ-rays and, more in particular, it relates to a scintillator for detecting radiation for use in medical application, for example, in PET (Positron Emission Tomography).

2. Description of the Related Art

Performance of medical equipments typically represented by positron emission tomography has been improved in a fast-evolving manner. In scintillators for detecting radiation such as y-rays for use in PET or the like, it is required for materials to supply excellent resolution for limited time, that is, materials which are exited by radiation and generate, upon emission of energy, fluorescence of fast attenuation time (preferably, several nsec or less).

Further, materials of excellent resolution for limited bulk, that is, materials having high density for increasing the absorbability of radiation per unit volume. On the other hand, with a viewpoint of the sensitivity of an instrument, a larger quantity of light (p.e./MeV:p.e. is photoelectron) is more advantageous.

As materials for satisfying the requirements described above, Bi₄Ge₃O₁₂ has been used so far. However, for coping with the increasing performance of medical equipments in recent years, various substances have been investigated looking for those materials having higher density and faster attenuation time of fluorescence than existent materials.

Table 1 shows characteristics of scintillator materials, which are actually used or considered to be usable for PET. The form of such scintillator materials are usually single crystals.

TABLE 1

| | CdWO₄ | Bi₄Ge₃O₁₂ | PbWO₄ | Gd₂SiO₅:Ce | Lu₂SiO₅:Ce |
|---|---|---|---|---|---|
| Density | 7.9 | 7.13 | 8.26 | 6.71 | 7.4 |
| Quantity | 38 | 10 | 0.4 | 20 | 75 |
| of light (*1) | | | | | |
| Fluorescence | 5,000 | 300 | <10 | 30-60 | 40 |
| attenuation | | | | | |
| time (nsec) | | | | | |

*1 Relative value based on B₁₄Ge₃O₁₂ = 10

At present, manufacture of PET has been tried by using, for example, Gd₂SiO₅:Ce, Lu₂SiO₅: Ce. However, while Gd₂SiO₅: Ce or Lu₂SiO₅: Ce emits a large quantity of light, it is not yet sufficient in view of density, and higher density has been demanded.

Because of its large quantity of light, CdWO₄ as one of tungstate salts has been used for X-ray CT, (X-ray transmission computed tomography) and the usefulness thereof has been demonstrated. However, for further increasing the detection sensitivity, larger quantity of light is desired.

PbWO₄ which is also a tungstate salt (hereinafter referred to as tungstate) is suitable for PET since it has high density and faster attenuation time of fluorescence. However, since the quantity of light of the existent PbWO₄, when exposed to an identical intensity of radiation is extremely small as 1/25 of Bi₄Ge₃O₁₂, 1/50 of Gd₂SiO₅:Ce and further 1/188 of Lu₂SiO₅:Ce as a relative value, it could not be utilized for PET. However with the outstanding improvement of the performance of a photo-diode as a photo-detector, in recent years, even a small quantity of light can be detected, and the minimum quantity of light that can be detected is said to be about twice of the existent PbWO₄.

Single crystals of PbWO₄ are prepared generally from tungsten trioxide (WO₃) and lead oxide (PbO) or PbWO₄ as a starting material, by heat melting the same in a platinum crucible and using a rotational pulling-up method (Czochralski method).

Various attempts have been made so far for increasing the quantity of light of PbWO₄ while taking its advantage of high density and fast attenuation time of fluorescence.

An example of them is addition of Mo. However, when Mo is added to PbWO₄, while the quantity of light seems to increase in a weak radiation, the quantity of light in an intense radiation is identical with that of crystals with no Mo addition, and the addition of Mo brings about the slower attenuation time of fluorescence.

Addition of a rare earth element Tb, Pr, Eu or Sm gives an effect of increasing the quantity of light but it involves a problem that the quantity of light from fluorescence of slow attenuation time increases while the quantity of light from fluorescence of fast attenuation time does not increase.

Further, it has also been developed a method of increasing the quantity of light by controlling the amount of Cd added to single crystals of PbWO₄ such that the value for X in the molecular formula: Pb₁₋ₓCdₓWO₄ is 0.01 or more and 0.30 or less. However, Pb₁₋ₓCd₁₋ₓWO₄ has a drawback in that cracks tend to be formed in the single crystals, as a result the yield reduce.

In addition to doping of other elements, it has also been developed a method of heating single crystals of PbWO₄ under vacuum thereby removing excess W and O to form crystals with no lattice defects (refer to Japanese Patent Application No. 212336/2001). While this method attains increase in the quantity of light twice or more compared with existent single crystals of PbWO₄, it merely reaches the required minimum quantity of light and, therefore, further increase in the quantity of light has been demanded for improving the sensitivity of instruments.

A scintillator using single crystals of tungstate, particularly, single crystals of PbWO₄, having faster attenuation time of fluorescence and showing large quantity of light has not yet been put to practical use.

As has been described above, increase of the quantity of light has been demanded for scintillators using single crystals of tungstates. Among all, it has been strongly demanded for scintillators using PbWO₄ single crystals as scintillators for detecting radiation for use in medical application such as in PET, which can increase the quantity of light at least by four times or more compared with scintillators using existent PbWO₄ single crystals.

This invention intends to overcome the foregoing problems and provide a scintillator for detecting radiation such as X-rays or γ-rays using single crystals of a tungstate to improve the quantity of light without deteriorating the performance for the attenuation time of fluorescence, particularly, a scintillator applicable to those for detecting radiation for use in medical application, for example, in PET.

### SUMMARY OF THE INVENTION

In accordance with this invention, the foregoing subject can be attained in a scintillator using single crystals of a tungstate in which single crystals of the tungstate are arranged in a crystal orientation that a crystal face where atoms maintain dense configuration and an incident direction of the radiation are in parallel with each other.

The present inventors have made an earnest study for preparing a scintillator emitting a large quantity of light and, as a result, found that the insufficiency in the quantity of light is caused by the great amount of lattice defects formed by the deviation of the compositional ratio of the tungstate single crystals from the stoichiometric ratio, as well as by the effects of the incident direction of the radiation to the single crystals.

Single crystals of PbWO₄ as one of typical tungstates are usually prepared in the atmospheric air. As apparent from the molecular formula, since oxygen (O) is a principal element constituting the crystal structure, concentration of O₂ in the atmosphere gives a significant effect on the formation of the lattice defects in the single crystals. It is considered that the lattice defects are formed as below. During preparation of single crystals, PbO is evaporated from the molten liquid and Pb⁴⁺ is formed in the solidified crystals while intaking O₂ in the atmosphere for compensating charges of decreased Pb²⁺ and, as a result, cations and anions are balanced, that is, (Pb²⁺+Pb⁴⁺) are equivalent with WO₄²⁻ or (WO₄²⁻+O²⁻) in view of electric charges, and the O/Pb and W/Pb atom ratio in the single crystals of PbWO₄ are deviated positively from the stoichiometrical ratio, thereby incorporating a great amount of lattice defects.

It is considered that when PbWO₄ single crystals are heated in an oxygen-free atmosphere, excess O and W contained in PbWO₄ single crystals are released as O₂ and WO₃ out of the crystals and, along therewith, Pb⁴⁻ resumes Pb²⁻ to transform the crystals into single crystals with less lattice defects. By the treatment, PbWO₄ single crystals change from transparent yellow to colorless transparent and transmittance of light, particularly, at 325-600 nm increases outstandingly, so that this treatment is suitable to a photo-diode that detects light at above 400 nm.

The tungstate single crystals removed with the lattice defects are cut into a predetermined size and polished such that the incident radiation are in parallel with the crystal face where atoms maintain dense configuration, and a photo-diode is joined to a surface opposite to the incident face of radiation.

The crystal face where atoms maintain dense configuration is different depending on the crystal structure of the tungstate and, since, the space group of the crystals usually belong to I41/a, P2/a or I2/a, (101) face, (100) face, (010) face, (001) face, (110) face, (111) face, (112) face and the like corresponding to such crystal face.

Bonding of atoms is strong within the crystal face where atoms maintain dense configuration, while bonding between the crystal faces to each other is weak where atoms maintain dense configuration. Typical example is a cleavage face. When radiation enter in parallel with the cleavage face, the radiation reach as far as the deep portion of the single crystals at a region where bonding between the crystal faces to each other is weak in which WO₄²⁻ is excited to emit a large quantity of light from the entire single crystals.

In the existent scintillators manufactured by cutting and polishing at random with no consideration for the crystal orientation, it is considered that not only the quantity of light varies greatly but also when radiation enter in the direction vertical to the crystal face where atoms maintain dense configuration, that is, to the cleavage face, most of incident radiation are absorbed at the surface of the single crystals to excite WO₄²⁻ only near the surface of the single crystals and no large quantity of light can be obtained.

The cleavage face of the tungstate is (101) face in PbWO₄, (010) face in CdWO₄ and (010) face in ZnWO₄.

While the quantity of light of a scintillator using existent PbWO₄ single crystals is about 30 p.e./MeV, the quantity of light of a scintillator using PbWO₄ single crystals heated in the absence of oxygen shows a quantity of light of 60 p.e./MeV or more, which is twice or more of the scintillator using existent PbWO₄ single crystals. When the (101) face of the PbWO₄ single crystals is arranged in parallel with the incident direction of the radiation, this treatment can provide a scintillator that shows 120 p.e./MeV or more which is four times as large as that in the scintillator using existent PbWO₄ single crystals and has the attenuation time of fluorescence comparable with the existent scintillator.

Among tungstate single crystals, CdWO₄ single crystals or ZnWO₄ single crystals are not suitable to scintillators for use in PET since the attenuation time is as long as 5000 nsec but they are optimal as X-ray CT scintillator and the detection sensitivity is further increased by arranging the (010) face of single crystals in parallel with the incident direction of the radiation.

### PREFERRED EMBODIMENT OF THE INVENTION

In a case of using PbWO₄ single crystals as tungstate single crystals, WO₃ and PbO or PbWO₄ are used as the starting material and heat-melted in a platinum crucible, and PbWO₄ single crystals are prepared by a Czochralski method.

For preparing PbWO₄ single crystals of good quality, oxides of other different valence such as WO₂ or PbO₂ in WO₃ and PbO used as the starting material have to be decreased as much as possible. Further, it is necessary to use PbWO₄ controlled by using them. The total amount of impurities is preferably 1×10⁻⁴ mol or less. Such oxides are optimum as the starting material but other starting materials may also be used so long as the aimed PbWO₄ single crystals can be prepared.

The prepared PbWO₄ single crystals are in the form of a pale yellow transparent and extremely fragile cylindrical ingot. The PbWO₄ single crystals are heated at 600 to 1100° C. in an Ar or N₂ atmosphere or in vacuum.

No particularly high purity is necessary for Ar or N₂ but it is preferred to use those at an O₂ concentration of 20 vol ppm or less. Referring to vacuum, the degree of vacuum is preferably 13 Pa or less and, if possible, 5×10⁻² Pa or less. In a case of heating in the Ar or N₂ atmosphere, the rate of flow is preferably from 0.5 to 5 L/min, which may be optionally changed in view of the size of the single crystals or the like.

The PbWO₄ single crystals may be heated in the form of a cylindrical ingot as it is. However, for rapidly diffusing excess O and W in the inside of crystals and releasing them in the form of O₂ and W₃ outside of the crystals in a short time, it is preferred to heat the same after cutting into a size considering the final polishing amount. A slicing machine having an inner peripheral blade or a blade saw causing less chipping for cut face is used for cutting and the ingot is cut so as to expose a face in parallel with the (101) face as the cleavage face.

When the heating temperature is lower than 600° C., diffusing rate of O and W in the crystals is slow and it takes a long time for releasing O₂ and WO₃ out of the crystals. On the other hand, at a temperature higher than 1100° C., since this is near the melting point of PbWO₄, it may lead to a risk of melting and, in addition, increases the evaporation amount of PbWO₄.

The PbWO₄ single crystals are heated being loaded on a platinum boat, and usually the heating time is appropriately from 12 to 96 Hr, while varying depending on the kind of the atmosphere and the size of the crystals.

The surface of the single crystals is clouded slightly when heated in an oxygen-free atmosphere but colorless transparent smooth surface appears when the surface is polished. After mirror polishing the crystals after the heat treatment, a photo-diode is joined to an end face opposite to the end face to which radiation are applied.

The quantity of light when γ-rays from a ⁶⁰Co source are irradiated in parallel with the (101) face of the single crystals is 120 p.e./MeV or more at the maximum and the attenuation time of fluorescence is kept at 10 nsec, and the scintillator shows excellent characteristics.

### EXAMPLES

### Example 1

WO₃ powder and PbO powder each at 99.99% purity were measured each in an equal molar amount, mixed and then placed in a platinum crucible of 70 mm diameter and 70 mm height, and the mixed starting powder was melted by radio frequency heating, and PbWO₄ single crystals of 35 mm diameter and 65 mm length were prepared from the molten liquid by a Czochralski method.

Then, the PbWO₄ single crystals were cut by a slicing machine having an inner peripheral blade to a size of 1.1 cm×1.1 cm×2.1 cm, in which the 1.1 cm ×2.1 cm face was made in parallel with the (101) face.

The cut PbWO₄ single crystals were loaded on a platinum boat and heated by using a furnace with vacuum pump at 950° C. for 72 Hr under 5×10⁻² Pa.

PbWO₄ single crystals after the heat treatment were mirror polished into a size of 1.0 cm×1.0 cm×2.0 cm and then a photo-diode was joined to one of 1.0 cm×1.0 cm end faces, γ-rays of a ⁶⁰Co source were irradiated from the other of the end faces, and the quantity of light and attenuation time of fluorescence were measured. The quantity of light was 120 p.e./MeV, which was about 4.0 times the existent PbWO₄ single crystals, and 10 nsec attenuation time of fluorescence was kept.

### Example 2

PbWO₄ single crystals were cut by a slicing machine having an inner periphery blade to a size of 1.1 cm×1.1 cm×2.1 cm in which the 1.0×2.1 cm face was made in parallel with the (112) face. Other treatments than described above were identical with those in Example 1.

The quantity of light and the attenuation time of fluorescence when γ-rays of a ⁶⁰Co source were irradiated from the end face of the single crystals were measured.

The quantity of light was 114 p.e./MeV, which was about 3.8 times the existent PbWO₄ single crystals and 10 nsec attenuation time of fluorescence was kept.

### Example 3

WO₃ powder and CdO powder at 99.99% purity were measured each in an equal molar amount, mixed and then placed in a platinum crucible of 70 mm diameter and 70 mm height and the mixed starting powder was melted by radio frequency heating, and CdWO₄ single crystals of 35 mm diameter and 65 mm length were prepared from the molten liquid by a Czochralski method.

Then, the CdWO₄ single crystals were cut by a slicing machine having an inner periphery blade to a size of 1.1 cm×1.1 cm×2.1 cm, in which the 1.1 cm×2.1 cm face was made in parallel with the (101) face.

The cut CdWO₄ single crystals were loaded on a platinum boat and heated by using a furnace with vacuum pump at 1000° C. for 48 Hr under 5×10⁻² Pa.

CdWO₄ single crystals after the heat treatment were mirror polished into a size of 1.0 cm×1.0 cm×2.0 cm and then a photo-diode was joined to one of 1.0 cm×1.0 cm end faces, γ-rays of a ⁶⁰Co source were irradiated from the other end face, and the quantity of light and attenuation time of fluorescence were measured.

The quantity of light was 4275 p.e./MeV, which was about 1.5 times the existent CdWO₄ single crystals and 5000 nsec of attenuation time of fluorescence was kept.

As has been described above, since the scintillator according to this invention is improved for the quantity of light without deteriorating the attenuation time of fluorescence, it is suitable to scintillators for detecting radiation such as x-rays or γ-rays and, particularly, it can be utilized as a scintillator used for detecting radiation in medical, for example, in PET.

What is claimed is:

1. A scintillator using single crystals of a tungstate in which the single crystals of the tungstate are arranged in a crystal orientation that the crystal face where atoms maintain dense configuration and the incident direction of the radiation are in parallel with each other.

2. A scintillator as defined in claim 1, wherein a cleavage face is selected as the crystal face where atoms maintain dense configuration.
